(19) United States
(12) Patent Application Publication
(10) Pub. No.: US 2026/0203570 A1
(43) Pub. Date: Jul. 16, 2026

(54) OPERATIONALIZING DEPLOYED MACHINE LEARNING MODELS IN SAFETY-CRITICAL OR OTHER APPLICATIONS THROUGH OUT-OF-DISTRIBUTION ROBUSTNESS QUANTIFICATION

(71) Applicant: Raytheon Company, Arlington, VA (US)

(72) Inventors: Sudeepta Mondal, Manchester, CT (US); Ganesh Sundaramoorthi, Duluth, GA (US)

(21) Appl. No.: 19/017,190

(22) Filed: Jan. 10, 2025

(51) Int. Cl. G06N 3/08; G06N 3/045

(52) U.S. Cl. CPC G06N 3/08; G06N 3/045

(57) ABSTRACT

A method includes receiving an input for a machine learning model having a transformer-based architecture with an embedding layer, an unembedding layer, and three or more transformer layers. The method also includes embedding the input at the embedding layer and passing the embedded input from the embedding layer across the transformer layers. Each transformer layer provides one or more feature outputs. The method further includes obtaining the feature output(s) from a first intermediate transformer layer. The method also includes generating an out-of-distribution (OOD) score for the received input based on the feature output(s) from the first intermediate transformer layer and one or more feature distributions from the first intermediate transformer layer. In addition, the method includes comparing the OOD score against a threshold and, in response to determining that the OOD score exceeds the threshold, passing one or more outputs from the unembedding layer to one or more downstream processes.

### TECHNICAL FIELD

This disclosure relates generally to machine learning systems and processes. More specifically, this disclosure relates to operationalizing deployed machine learning models (such as large language models) in safety-critical or other applications through out-of-distribution robustness quantification.

### BACKGROUND

Artificial intelligence/machine learning (“AI/ML”) models utilizing transformer-based architectures form the analytical backbone of a wide variety of AI/ML systems. Some transformer-based models can represent large language models (LLMs), which can be trained and integrated into systems that receive natural language inputs (such as “What is the weather today?”) and provide natural language responses (such as “It is sunny today.”). When inputs to an LLM or other transformer-based system are similar to a training set upon which the model was trained, a system can be said to be operating “in distribution.” However, when the inputs to the LLM or other transformer-based system are dissimilar to the training set, the inputs can be said to be “out of distribution.” When operating out-of-distribution, an LLM or other transformer-based system can issue responses that are illogical, incorrect, or otherwise misleading.

### SUMMARY

This disclosure relates to operationalizing deployed machine learning models in safety-critical or other applications through out-of-distribution robustness quantification.

In some embodiments, a method includes receiving an input for a machine learning model having a transformer-based architecture. The transformer-based architecture includes an embedding layer, an unembedding layer, and three or more transformer layers logically disposed between the embedding layer and the unembedding layer. The method also includes embedding the input at the embedding layer and passing the embedded input from the embedding layer across the three or more transformer layers of the machine learning model, where each transformer layer provides one or more feature outputs. The method further includes obtaining the one or more feature outputs from a first intermediate transformer layer of the three or more transformer layers. The method also includes generating an out-of-distribution (OOD) score for the received input based on the one or more feature outputs from the first intermediate transformer layer and one or more feature distributions from the first intermediate transformer layer obtained by passing embedded in-distribution inputs through the machine learning model. In addition, the method includes comparing the OOD score for the received input against a threshold and, in response to determining that the OOD score for the received input exceeds the threshold, passing one or more outputs from the unembedding layer to one or more downstream processes.

In some embodiments, an apparatus includes at least one processing device configured to receive an input for a machine learning model having a transformer-based architecture. The transformer-based architecture includes an embedding layer, an unembedding layer, and three or more transformer layers logically disposed between the embedding layer and the unembedding layer. The at least one processing device is also configured to embed the input at the embedding layer and pass the embedded input from the embedding layer across the three or more transformer layers of the machine learning model, where each transformer layer is configured to provide one or more feature outputs. The at least one processing device is further configured to obtain the one or more feature outputs from a first intermediate transformer layer of the three or more transformer layers. The at least one processing device is also configured to generate an OOD score for the received input based on the one or more feature outputs from the first intermediate transformer layer and one or more feature distributions from the first intermediate transformer layer obtained by passing embedded in-distribution inputs through the machine learning model. In addition, the at least one processing device is configured to compare the OOD score for the received input against a threshold and, in response to determining that the OOD score for the received input exceeds the threshold, pass one or more outputs from the unembedding layer to one or more downstream processes.

In some embodiments, a non-transitory machine-readable medium contains instructions that when executed cause at least one processor to receive an input for a machine learning model having a transformer-based architecture. The transformer-based architecture includes an embedding layer, an unembedding layer, and three or more transformer layers logically disposed between the embedding layer and the unembedding layer. The non-transitory machine-readable medium also contains instructions that when executed cause the at least one processor to embed the input at the embedding layer and pass the embedded input from the embedding layer across the three or more transformer layers of the machine learning model, where each transformer layer is configured to provide one or more feature outputs. The non-transitory machine-readable medium further contains instructions that when executed cause the at least one processor to obtain the one or more feature outputs from a first intermediate transformer layer of the three or more transformer layers. The non-transitory machine-readable medium also contains instructions that when executed cause the at least one processor to generate an OOD score for the received input based on the one or more feature outputs from the first intermediate transformer layer and one or more feature distributions from the first intermediate transformer layer obtained by passing embedded in-distribution inputs through the machine learning model. In addition, the non-transitory machine-readable medium contains instructions that when executed cause the at least one processor to compare the OOD score for the received input against a threshold and, in response to determining that the OOD score for the received input exceeds the threshold, pass one or more outputs from the unembedding layer to one or more downstream processes.

Any single one or any combination of the following features may be used with the example embodiments described above. In response to determining that the OOD score for the received input does not exceed the threshold, the one or more outputs may not be passed from the unembedding layer to the one or more downstream processes, and/or the one or more outputs of the unembedding layer may be flagged as being based on an OOD input. The machine learning model may include a large language model (LLM). The OOD score may be generated using a likelihood-based approach, and the OOD score may be a composite probability based on (for each of the one or more feature distributions from the first intermediate transformer layer) a probability that the one or more feature outputs from the first intermediate transformer layer belongs to that one of the one or more feature distributions. The OOD score may be generated using a feature distance-based approach, the feature distance-based approach may include calculating a Mahalanobis distance between the one or more feature outputs from the first intermediate transformer layer and at least one of the one or more feature distributions from the first intermediate transformer layer, and the OOD score may be based on the Mahalanobis distance.

The OOD score may be generated using a network confidence based approach, the network confidence-based approach may include determining a feature distribution of the one or more feature distributions from the first intermediate transformer layer as a most likely class for the one or more feature outputs from the first intermediate transformer layer, and the OOD score may be based on a probability of the one or more feature outputs from the first intermediate transformer layer belonging to the most likely class. One or more second feature outputs may be obtained from a second intermediate transformer layer of the machine learning model. The OOD score may be based on the one or more feature outputs from the first intermediate transformer layer, the one or more feature distributions, the one or more second feature outputs from the second intermediate transformer layer, and one or more second feature distributions from the second intermediate transformer layer obtained by passing the embedded in-distribution inputs through the machine learning model.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A and 1B illustrate examples of a precomputation pipeline for out-of-distribution (OOD) input detection and an OOD input detection pipeline according to this disclosure;

FIGS. 2A and 2B illustrate examples of scoring functions for determining OOD scores according to this disclosure;

FIG. 3 illustrates an example method for OOD input detection according to this disclosure; and

FIG. 4 illustrates an example device for implementing OOD input detection according to this disclosure.

### DETAILED DESCRIPTION

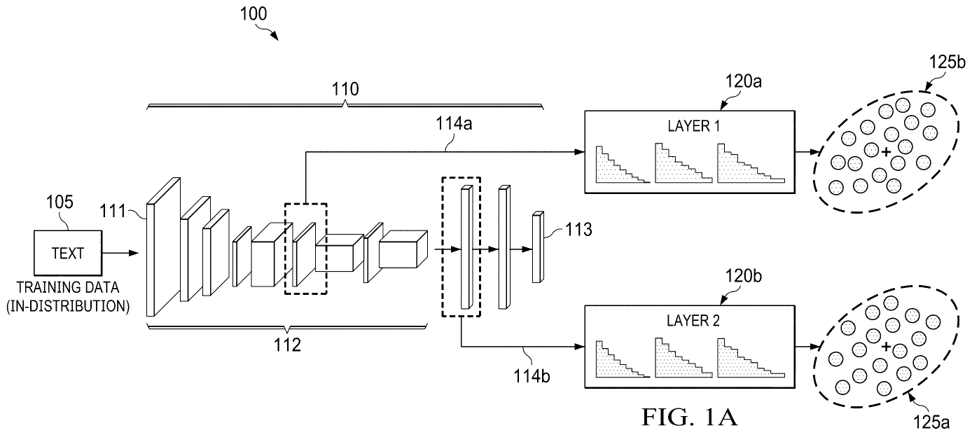

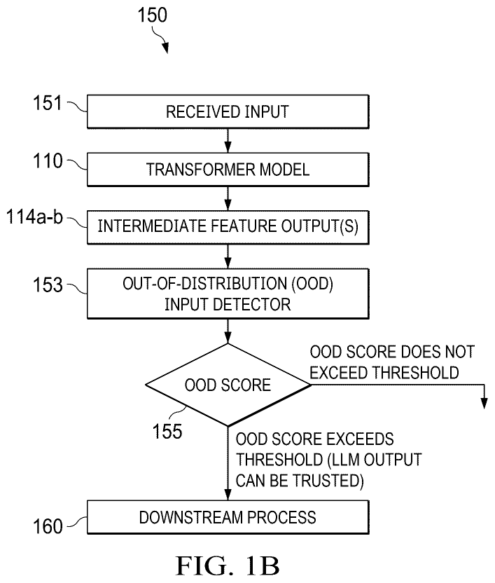

FIGS. 1A through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, artificial intelligence/machine learning (“AI/ML”) models utilizing transformer-based architectures form the analytical backbone of a wide variety of AI/ML systems. Some transformer-based models can represent large language models (LLMs), which can be trained and integrated into systems that receive natural language inputs (such as “What is the weather today?”) and provide natural language responses (such as “It is sunny today.”). When inputs to an LLM or other transformer-based system are similar to a training set upon which the model was trained, a system can be said to be operating “in distribution.” However, when the inputs to the LLM or other transformer-based system are dissimilar to the training set, the inputs can be said to be “out of distribution.” When operating out-of-distribution, an LLM or other transformer-based system can issue responses that are illogical, incorrect, or otherwise misleading.

Managing the behavior of LLMs or other transformer-based AI/ML-based systems in response to out-of-distribution inputs is a persistent source of challenges. For example, LLMs may not have encountered every word or topic combination that users can present during training and fine tuning. Put differently, the training set for an LLM or other transformer-based model includes a finite distribution of possibilities and feature combinations. When presented with inputs that are out-of-distribution (or meaningfully dissimilar) to the training set, LLMs or other transformer-based models can exhibit one or more types of degraded performance. Examples of different types of degraded performance can include outputting responses that are irrelevant or incorrect or outputting overconfident but misleading responses that seem plausible but that are factually incorrect, outdated, or otherwise wrong. Other undesirable performance may include vulnerability to adversarial or malicious attacks, such as when users deliberately craft problematically OOD inputs in order to obtain biased or inappropriate responses. Macro-level trends within the art currently include a general movement towards larger and larger models having multiple billions of parameters. However, testing has shown that scale and model depth do not correlate to robust, error-free response to OOD inputs.

This disclosure provides various techniques for operationalizing deployed machine learning models in safety-critical or other applications through out-of-distribution robustness quantification. As described in more detail below, an input for a machine learning model having a transformer-based architecture can be obtained. The transformer-based architecture can include an embedding layer, an unembedding layer, and three or more transformer layers logically disposed between the embedding layer and the unembedding layer. The input can be embedded at the embedding layer, and the embedded input can be passed from the embedding layer across the three or more transformer layers. Each transformer layer can be configured to provide one or more feature outputs. The one or more feature outputs from a first intermediate transformer layer of the three or more transformer layers can be obtained, and an OOD score for the received input can be generated. The OOD score can be based on the one or more feature outputs from the first intermediate transformer layer and one or more feature distributions from the first intermediate transformer layer obtained by passing embedded in-distribution inputs through the machine learning model. The OOD score for the received input can be compared against a threshold. In response to determining that the OOD score for the received input exceeds the threshold, one or more outputs from the unembedding layer can be passed to one or more downstream processes. In response to determining that the OOD score for the received input does not exceed the threshold, the one or more outputs from the unembedding layer may not be passed to the one or more downstream processes, and/or the one or more outputs of the unembedding layer may be flagged as being based on an OOD input. In this way, embodiments according to the present disclosure enhance the robustness of LLMs and other transformer-based systems by providing the ability to predict whether an input is in-distribution or OOD. From this, users can ascribe varying levels of confidence or trust to the systems' outputs.

FIGS. 1A and 1B illustrate examples of a precomputation pipeline 100 for OOD input detection and an OOD input detection pipeline 150 according to this disclosure. In some embodiments, the precomputation pipeline 100 can be implemented using any suitable processing platform capable of implementing a transformer-type machine learning model. Examples of processing platforms suitable for implementing the precomputation pipeline 100 may include cloud computing platforms and neural processing units (NPUs).

As shown in FIG. 1A, the precomputation pipeline 100 includes or has access to a corpus of training data 105. The corpus of training data 105 can represent a vetted set of training data that, by definition, is in distribution for a transformer model 110. In some embodiments, the corpus of training data 105 includes a first larger corpus of generic training data used for pretraining the transformer model 110 (such as the “Common Crawl” or “The Pile” datasets commonly used for pretraining LLMs) and a second smaller corpus of more task-specific training data.

The precomputation pipeline 100 includes the transformer model 110, which represents a deep learning model or other machine learning model having a transformer-based architecture. The transformer-based architecture includes at least one embedding layer 111, one or more transformer layers 112, and an unembedding layer 113. According to various embodiments, the embedding layer 111 can receive tokens, which represent individual units of data extracted from the corpus of training data 105. The embedding layer 111 can embed the tokens into vector representations of the data. The one or more transformer layers 112 can include a series of alternating attention and feedforward layers that carry out multiple transformations on the vector representations of the data. The last transformer layer feeds the transformed vector representations to the unembedding layer 113, which converts the transformed vector representations back into output data.

The transformer model 110 also generates intermediate feature outputs 114a and 114b, which are obtained from one or more intermediate layers of the transformer layers 112. As skilled artisans will appreciate, the transformer model 110 can include a sequence of transformer layers 112, such as a first transformer layer that receives the output of the embedding layer(s) 111 and a final transformer layer (sometimes referred to as the penultimate layer of a model) that feeds the transformed vector representations to the unembedding layer 113. As used in this disclosure, the expressions “intermediate transformer layer” or “intermediate layer” refer to a transformer layer of a machine learning model that precedes the last or final transformer layer of the machine learning model. An intermediate transformer layer may therefore represent the first transformer layer or a transformer layer logically between the first transformer layer and the final transformer layer.

The historical trend for OOD input detection, in particular with respect to convolutional neural networks (“CNNs”) and models that do not utilize transformer-based architectures and that are developed to solve classification problems (such as computer vision problems) has been to focus on outputs of the penultimate layer rather than intermediate layers of a model. Thus, the intermediate layers of models historically have not generally been considered as being useful for OOD input detection.

The precomputation pipeline 100 here is configured to generate layer-wise feature statistics 120a and 120b based on the intermediate feature outputs 114a and 114b. The layer-wise feature statistics 120a and 120b may include statistics showing distributions of intermediate feature values obtained from the in-distribution inputs contained in the corpus of training data 105. In other words, the layer-wise feature statistics 120a and 120b can include statistics of the values of vectors generated by the embedding layer(s) 111 after undergoing some (but not all) of the transformations performed by the transformer layers 112 of the transformer model 110.

The layer-wise feature statistics 120a and 120b can be used to generate one or more feature distributions 125a and 125b, which represent distributions of the feature values generated using the in-distribution inputs contained in the corpus of training data 105. For example, in some embodiments, the feature outputs from a first of the transformer layers 112 can be defined as z₁, and the feature outputs from a second of the transformer layers 112 can be defined as z₂. In certain embodiments, the outputs of the first and second transformer layers from in-distribution inputs can be defined as being class conditional and can present values adhering to a Gaussian or “bell curve” distribution. From this, the one or more feature distributions 125a and 125b can be obtained by fitting to the layer-wise feature statistics associated with the feature outputs z₁ and z₂ in order to obtain a first feature distribution [symbol] (z₁|μ₁, Σ₁) associated with the first transformer layer and a second feature distribution [symbol] (z₂|μ₂, Σ₂) associated with the second transformer layer.

As implied by the depiction of the feature distributions 125a and 125b as two-dimensional ovals in FIG. 1A, the determined feature distributions of the transformer layer outputs for in-distribution inputs can be one dimensional (such as a bell curve distribution of values of a single feature) or multi-dimensional (such as a multi-dimensional distribution of values across multiple feature axes). As will be discussed with reference to FIG. 1B below, the one or more feature distributions 125a and 125b obtained by feeding in-distribution inputs to the transformer model 110 and collecting the layer-wise feature statistics 120a and 120b associated with the in-distribution inputs at one or more intermediate transformer layers of the transformer model 110 can be repurposed to provide robust OOD input detection functionality when the transformer model 110 is deployed and provided with new inputs (such as inputs not included within the corpus of training data 105). In some embodiments, there can be multiple feature distributions within a given coordinate space, such as an N-dimensional Euclidean coordinate space.

FIG. 1B illustrates an example of the OOD input detection pipeline 150, which can build upon the precomputation pipeline 100 of FIG. 1A. For consistency and convenience of cross-reference, elements of FIG. 1B previously described with reference to FIG. 1A are numbered similarly. As shown in FIG. 1B, the OOD input detection pipeline 150 receives an input 151, where the received input 151 can have an analogous format as the items of data in the corpus of training data 105. For example, if the corpus of training data 105 includes text, the received input 151 can include text. However, because the received input 151 is not part of the corpus of training data 105, the extent to which the content of the received input 151 is similar or dissimilar to the corpus of training data 105 is initially unknown. Thus, the received input 151 may or may not represent a significantly OOD input for which the transformer model 110 provides an undesirable output. The OOD input detection pipeline 150 here adds robustness by quantifying the extent to which the received input 151 is OOD and likely to cause the transformer model 110 to issue problematic outputs.

The OOD input detection pipeline 150 includes the transformer model 110, which has the structure and operation described above with reference to FIG. 1A. The transformer model 110 can process the received input 151 and generate (among other things) the one or more intermediate feature outputs 114a and 114b. The one or more intermediate feature outputs 114a and 114b can be obtained from partial processing of the received input 151 through one or more intermediate transformer layers 112 of the transformer model 110. Here, the intermediate feature outputs 114a and 114b can be obtained from the same intermediate transformer layers within the transformer model 110 and in the same way as when implementing the precomputation pipeline 100 in FIG. 1A.

The OOD input detection pipeline 150 includes an OOD input detector 153, which applies a scoring function or other function to obtain an OOD score 155 for the received input 151. The OOD score 155 quantifies the extent to which the intermediate feature outputs 114a and 114b generated using the received input 151 are within, close to, or outside of the feature distributions 125a and 125b obtained from processing the corpus of training data 105 using the precomputation pipeline 100. As discussed in greater detail below, embodiments of this disclosure can utilize one of a plurality of scoring functions, such as a network confidence-based scoring function and a feature distance-based scoring function.

When the OOD score 155 exceeds a defined threshold, the received input 151 is considered sufficiently in-distribution so as to not cause OOD input-related performance issues in the transformer model 110. As a result, one or more outputs of the transformer model 110 based on the received input 151 can be passed to one or more downstream processes 160, which may represent part of a task-specific system incorporating the OOD input detection pipeline 150. In some cases, the one or more downstream processes 160 can include one or more additional AI/ML models that have been trained to further transform, classify, or otherwise utilize trusted outputs of the transformer model 110. As particular examples, the one or more downstream processes 160 can include one or more databases, user interfaces, or applications that consume the trusted outputs of the transformer model 110.

When the OOD score 155 fails to exceed the defined threshold, the received input 151 can be classified as sufficiently out-of-distribution so as to raise issues regarding the trustworthiness of the one or more outputs of the transformer model 110 based on the received input 151. In such cases, the one or more outputs of the transformer model 110 based on the received input 151 and associated with the low OOD score 155 can be flagged, not passed to the one or more downstream processes 160, or otherwise processed or handled differently from outputs with OOD scores satisfying the defined threshold.

Although FIGS. 1A and 1B illustrate one example of a precomputation pipeline 100 and one example of an OOD input detection pipeline 150, various changes may be made to FIGS. 1A and 1B. For example, various components, operations, or functions in each of FIGS. 1A and 1B may be combined, further subdivided, replicated, omitted, or rearranged and additional components, operations, or functions may be added according to particular needs. Also, OOD input detection can be conducted based on one or more OOD scores associated with one or more intermediate transformer levels of the transformer model 110.

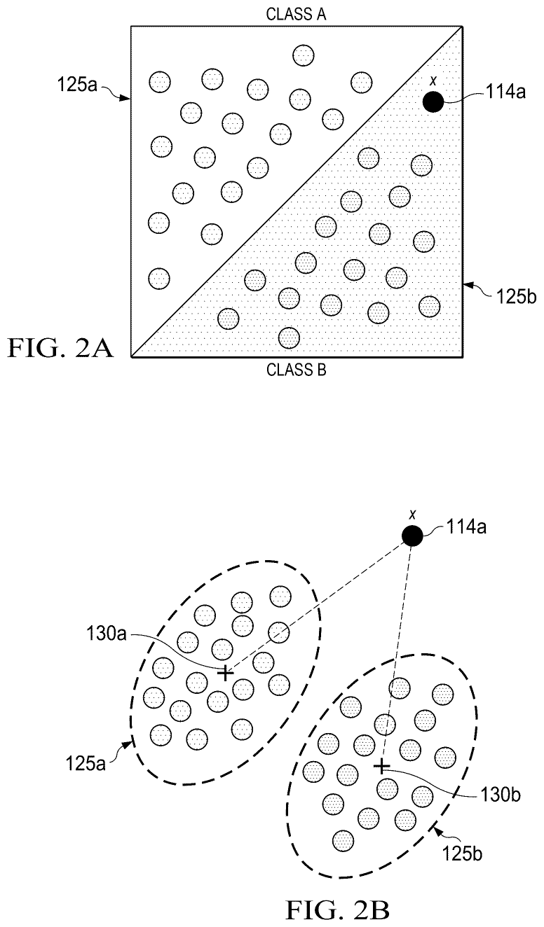

FIGS. 2A and 2B illustrate examples of scoring functions for determining OOD scores according to this disclosure. These scoring functions can be used to identify the extent to which an input is OOD based on the correspondence of outputs obtained at one or more intermediate layers of a transformer model (such as the transformer model 110) to one or more feature distributions (such as the feature distributions 125a and 125b) obtained from the same intermediate layers of the transformer model. As described above, the one or more feature distributions can be obtained by providing in-distribution inputs (such as the corpus of training data 105) to the model. Once an OOD score (such as the OOD score 155) can be ascribed to an input (such as the received input 151), the OOD score can be compared against a threshold value, and the outputs of the transformer model can be handled according to the OOD score. As noted above, scoring functions suitable for determining OOD scores for model inputs may include a network confidence-based scoring function and a feature distance-based scoring function. For consistency and convenience of cross-reference, elements of FIGS. 2A and 2B described elsewhere in this disclosure are numbered similarly.

FIG. 2A provides a visualization of a network confidence-based approach to scoring the correspondence between obtained intermediate feature outputs 114a and 114b and associated feature distributions 125a and 125b. According to some embodiments, the obtained feature distributions 125a and 125b from the one or more intermediate layers of the transformer model 210 are defined as classes. A “most likely” class for each of the one or more intermediate feature outputs 114a and 114b is determined, and an OOD score is determined based on an estimated prediction confidence that the intermediate feature output belongs to the most likely class. Examples of approaches for performing network confidence-based scoring could include Maximum Softmax Probability (MSP) approaches and energy-based approaches based on Helmholtz free energy.

In the example of FIG. 2A, in some embodiments, each feature distribution 125a and 125b can be defined as a class (such as Class “A” and Class “B” as shown here). Given an intermediate feature output 114a, a most likely class for the intermediate feature output 114a can be determined. In this example, Class “B” corresponding to the feature distribution 125b is identified as the most likely class for the intermediate feature output 114a. A probability that the intermediate feature output 114a belongs to the feature distribution 125b can be calculated, and the OOD score associated with the intermediate feature output 114a can represent or be based on the calculated probability. In this example, a low probability that the intermediate feature output 114a belongs to the most likely class correlates to a lower OOD score, and a high probability that the intermediate feature output 114a belongs to the most likely class correlates to a higher OOD score.

FIG. 2B provides a visualization of a feature distance-based approach to scoring the correspondence between obtained intermediate feature outputs 114a and 114b and associated feature distributions 125a and 125b. In the example of FIG. 2B, the feature distributions 125a and 125b can be represented as masses in an N-dimensional Euclidean space. Coordinate values of centroids 130a and 130b (centers of mass) corresponding to the feature distributions 125a and 125b can be calculated. From this, distances (such as Mahalanobis distances) between each intermediate feature output 114a or 114b and the calculated centroids 130a and 130b can be determined, and the OOD score can represent or be based on one or more of the calculated distances. For example, in some embodiments, the OOD score can be determined based on the distance between the coordinate value of the intermediate feature output 114a or 114b and the closest centroid. In other embodiments, the OOD score can be determined based on the combined distance between the intermediate feature output 114a or 114b and a predetermined number of nearby centroids.

Although FIGS. 2A and 2B illustrate examples of scoring functions for determining OOD scores, various changes may be made to FIGS. 2A and 2B. For example, the specific intermediate feature outputs and feature distributions shown here are examples only. Also, other or additional scoring functions are possible and within the scope of this disclosure.

As a particular example of another possible scoring function, in some embodiments, the scoring function applied by an OOD input detector (such as the OOD input detector 153) can represent a scoring function embodying a likelihood-based approach. The likelihood-based approach can be based on a composite of the probabilities of an intermediate feature output 114a or 114b belonging to each of the determined feature distributions 125a and 125b. As noted previously, for intermediate feature outputs z₁ (obtained from a first intermediate transformer layer) and intermediate feature outputs z₂ (obtained from a second intermediate layer), Gaussian distributions can be fitted such that the distribution of features obtained from the first intermediate layer can be given as [symbol] (z₁|μ₁, Σ₁) and the distribution of features obtained from the second intermediate layer can be given as [symbol] (z₂|μ₂, Σ₂). Having obtained a plurality of feature distributions, for an intermediate feature value x, the OOD score can be given as the joint likelihood that the intermediate feature value x belongs each of the feature distributions. Thus, when there are k feature distributions, the OOD score S for an intermediate feature as calculated by a likelihood-based approach could be defined as follows.

$$S ( x ) = P r ( {z}_{1} \vert {μ}_{1} , {\sum }_{1} ) P r ( {z}_{2} \vert {μ}_{2} , {\sum }_{2} ) … Pr ( {z}_{k} \vert {μ}_{k} , {\sum }_{k} )$$

As noted above, much of the work performed historically for OOD input detection has focused on CNNs, which (unlike transformer networks) extract features hierarchically between layers rather than by employing self-attention to obtain features more globally across layers. For example, text-oriented transformer-based language models can create text representations that progress gradually from representations that encode morphological and syntactic information at lower layers (where these representations can often be too general for OOD input detection) to representations that encode semantic task-specific meanings in upper layers (where these representations can be too specific for OOD input detection).

Subsequently, the remaining hyperparameters may be determined, such as by using one or more hyperparameter optimization techniques like a grid search, a random search, or a Bayesian optimization. The intermediate layer can be selected to optimize one or more performance metrics (such as False Positive Rate at True Positive Rate 95%) on a validation data set, which may include a mixture of in-distribution inputs and estimated OOD inputs. The layer outputs are subsequently provided to a scoring function S, which provides an OOD score (such as the OOD score 155) from which outputs can be classified according to a classification function G. In some cases, the classification function G may be defined as follows.

$$G ( x ) = \{ \begin{matrix}in & S ( f ( z ) ) \geq λ \\ out & S ( f ( z ) ) < λ\end{matrix}$$

Here, λ is a threshold OOD score value, such as a threshold for which model outputs are sufficiently trustworthy for use by one or more downstream processes 160.

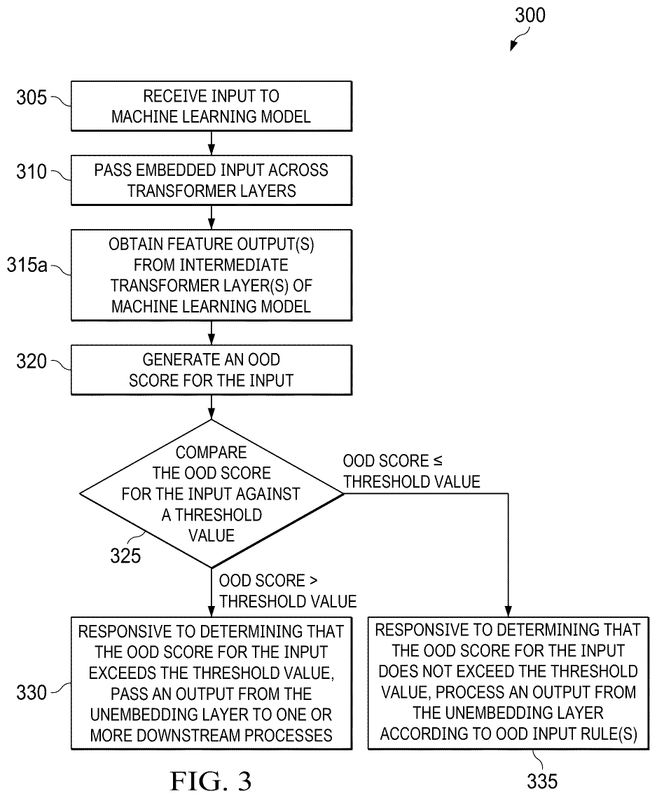

FIG. 3 illustrates an example method 300 for OOD input detection according to this disclosure. The operations described with reference to FIG. 3 can be performed on any suitable platform capable of implementing machine learning models with transformer-based architectures (such as the transformer model 110). One example of such a platform is described below with reference to FIG. 3.

As shown in FIG. 3, the method 300 begins at operation 305, where a machine learning model (such as the transformer model 110) employing a transformer-based architecture receives an input (such as the received input 151) at an embedding layer (such as the embedding layer 111) of the machine learning model. The input is embedded and converted into an embedding or a vector of values corresponding to its features. The received input can be sufficiently similar to the data upon which the transformer model 110 was trained (the corpus of training data 105) so as to be an in-distribution input or sufficiently dissimilar so as to be an out-of-distribution input.

At operation 310, the embedded input is passed from the embedding layer across the transformer layers (such as the transformer layers 112) of the machine learning model. According to certain embodiments, the machine learning model includes a sufficient number of transformer layers 112 (such as three or more transformer layers) to provide one or more intermediate layers. At operation 315a, one or more feature outputs (such as the intermediate feature outputs 114a or 114b) from one or more intermediate transformer layers of the machine learning model are obtained. As noted above, the obtained feature output(s) can be based on a partial set of transformations applied to the embedded input.

At operation 320, an OOD score (such as an OOD score 155) is obtained based on a determined metric of similarity between the feature output(s) obtained at operation 315 and one or more feature distributions (such as one or more feature distributions 125a-125b). As described above, the one or more feature distributions can be obtained from feature outputs generated via a precomputation pipeline (such as the precomputation pipeline 100) at the same intermediate transformer layer(s) using in-distribution data inputs. In some embodiments, the OOD score can be generated using one or more scoring functions, such as one or more scoring functions utilizing a network confidence-based approach, a feature distance-based approach, and/or a likelihood-based approach. In some cases, the obtained OOD score may include a numerical value that can be compared against a threshold value at operation 325. Based on the comparison, the input received at operation 405 can be characterized as either in-distribution or OOD.

At operation 430, responsive to determining that the OOD score exceeds the threshold value, one or more outputs of the machine learning model (which may be generated using the unembedding layer 113 based on the final transformer layer of the transformer model 110) can be passed to one or more downstream processes (such as the downstream process or processes 160). Alternatively, in response to a determination that the OOD score does not exceed the threshold value, the one or more outputs of the machine learning model are processed according to one or more rules for model outputs that present a credible likelihood of being generated in response to an OOD input at operation 335.

Although FIG. 3 illustrate one example of a method 300 for OOD input detection, various changes may be made to FIG. 3. For example, while shown as a series of steps, various steps in FIG. 3 may overlap, occur in parallel, occur in a different order, or occur any number of times (including zero times).

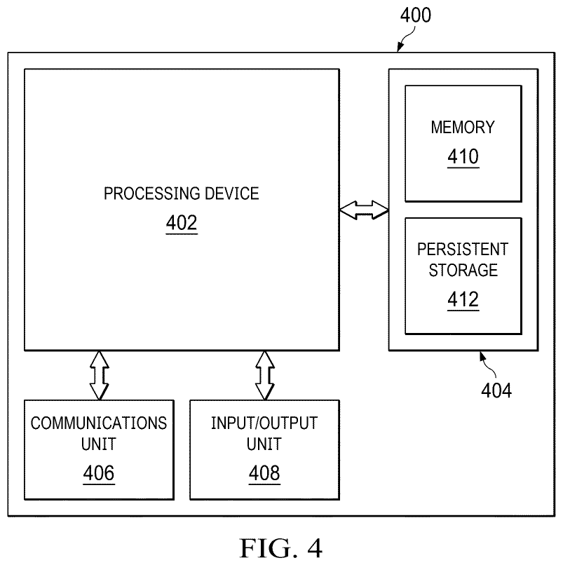

FIG. 4 illustrates an example device 400 for implementing OOD input detection according to the present disclosure. One or more instances of the device 400 (or portions thereof) may, for example, be used to at least partially implement the precomputation pipeline 100 of FIG. 1A and/or the OOD input detection pipeline 150 of FIG. 1B. One or more instances of the device 400 (or portions thereof) may also be used to perform the method 300 of FIG. 3. However, each of the pipelines, processes, and methods may be implemented in any other suitable manner.

As shown in FIG. 4, the device 400 denotes a computing device or system that includes at least one processing device 402, at least one storage device 404, at least one communications unit 406, and at least one input/output (I/O) unit 408. The processing device 402 may execute instructions that can be loaded into a memory 410. The processing device 402 includes any suitable number(s) and type(s) of processors or other devices in any suitable arrangement. Example types of processing devices 402 include one or more microprocessors, microcontrollers, digital signal processors (DSPs), application-specific integrated circuits (ASICs), field programmable gate arrays (FPGAs), graphics processing units (GPUs), NPUs, or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random-access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. For example, the communications unit 406 can include a network interface card or a wireless transceiver facilitating communications over a wired or wireless network. The communications unit 406 may support communications through any suitable physical or wireless communication link(s).

The I/O unit 408 allows for input and output of data. For example, the I/O unit 408 may provide a connection for user input through a keyboard, mouse, keypad, touchscreen, or other suitable input device. The I/O unit 408 may also send output to a display or other suitable output device. Note, however, that the I/O unit 408 may be omitted if the device 400 does not require local I/O, such as when the device 400 can be accessed remotely or operated autonomously.

Although FIG. 4 illustrates one example of a device 400 for implementing OOD input detection, various changes may be made to FIG. 4. For example, computing devices and systems come in a wide variety of configurations, and FIG. 4 does not limit this disclosure to any particular computing device or system.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving an input for a machine learning model having a transformer-based architecture, the transformer-based architecture comprising an embedding layer, an unembedding layer, and three or more transformer layers logically disposed between the embedding layer and the unembedding layer;
embedding the input at the embedding layer and passing the embedded input from the embedding layer across the three or more transformer layers of the machine learning model, wherein each transformer layer provides one or more feature outputs;
obtaining the one or more feature outputs from a first intermediate transformer layer of the three or more transformer layers;
generating an out-of-distribution (OOD) score for the received input based on the one or more feature outputs from the first intermediate transformer layer and one or more feature distributions from the first intermediate transformer layer obtained by passing embedded in-distribution inputs through the machine learning model;
comparing the OOD score for the received input against a threshold; and
in response to determining that the OOD score for the received input exceeds the threshold, passing one or more outputs from the unembedding layer to one or more downstream processes.

2. The method of claim 1, further comprising:
in response to determining that the OOD score for the received input does not exceed the threshold, at least one of:
not passing the one or more outputs from the unembedding layer to the one or more downstream processes; or
flagging the one or more outputs of the unembedding layer as being based on an OOD input.

3. The method of claim 1, wherein the machine learning model comprises a large

4. The method of claim 1, wherein:
the OOD score is generated using a likelihood-based approach; and
the OOD score is a composite probability based on, for each of the one or more feature distributions from the first intermediate transformer layer, a probability that the one or more feature outputs from the first intermediate transformer layer belongs to that one of the one or more feature distributions.

5. The method of claim 1, wherein:
the OOD score is generated using a feature distance-based approach;
the feature distance-based approach comprises calculating a Mahalanobis distance between the one or more feature outputs from the first intermediate transformer layer and at least one of the one or more feature distributions from the first intermediate transformer layer; and
the OOD score is based on the Mahalanobis distance.

6. The method of claim 1, wherein:
the OOD score is generated using a network confidence-based approach;
the network confidence-based approach comprises determining a feature distribution of the one or more feature distributions from the first intermediate transformer layer as a most likely class for the one or more feature outputs from the first intermediate transformer layer; and
the OOD score is based on a probability of the one or more feature outputs from the first intermediate transformer layer belonging to the most likely class.

7. The method of claim 1, further comprising:
obtaining one or more second feature outputs from a second intermediate transformer layer of the machine learning model;
wherein the OOD score is based on the one or more feature outputs from the first intermediate transformer layer, the one or more feature distributions, the one or more second feature outputs from the second intermediate transformer layer, and one or more second feature distributions from the second intermediate transformer layer obtained by passing the embedded in-distribution inputs through the machine learning model.

8. An apparatus comprising:
at least one processing device configured to:
receive an input for a machine learning model having a transformer-based architecture, the transformer-based architecture comprising an embedding layer, an unembedding layer, and three or more transformer layers logically disposed between the embedding layer and the unembedding layer;
embed the input at the embedding layer and pass the embedded input from the embedding layer across the three or more transformer layers of the machine learning model, wherein each transformer layer is configured to provide one or more feature outputs;
obtain the one or more feature outputs from a first intermediate transformer layer of the three or more transformer layers;
generate an out-of-distribution (OOD) score for the received input based on the one or more feature outputs from the first intermediate transformer layer and one or more feature distributions from the first intermediate transformer layer obtained by passing embedded in-distribution inputs through the machine learning model;
compare the OOD score for the received input against a threshold; and
in response to determining that the OOD score for the received input exceeds the threshold, pass one or more outputs from the unembedding layer to one or more downstream processes.

9. The apparatus of claim 8, wherein the at least one processing device is further configured, in response to determining that the OOD score for the received input does not exceed the threshold, to at least one of:
not pass the one or more outputs from the unembedding layer to the one or more downstream processes; or
flag the one or more outputs of the unembedding layer as being based on an OOD input.

10. The apparatus of claim 8, wherein the machine learning model comprises a large

11. The apparatus of claim 8, wherein:
the at least one processing device is configured to generate the OOD score using a likelihood-based approach; and
the OOD score is a composite probability based on, for each of the one or more feature distributions from the first intermediate transformer layer, a probability that the one or more feature outputs from the first intermediate transformer layer belongs to that one of the one or more feature distributions.

12. The apparatus of claim 8, wherein:
to generate the OOD score, the at least one processing device is configured to use a feature distance-based approach;
to use the feature distance-based approach, the at least one processing device is configured to calculate a Mahalanobis distance between the one or more feature outputs from the first intermediate transformer layer and at least one of the one or more feature distributions from the first intermediate transformer layer; and
the OOD score is based on the Mahalanobis distance.

13. The apparatus of claim 8, wherein:
to generate the OOD score, the at least one processing device is configured to use a network confidence-based approach;
to use the network confidence-based approach, the at least one processing device is configured to determine a feature distribution of the one or more feature distributions from the first intermediate transformer layer as a most likely class for the one or more feature outputs from the first intermediate transformer layer; and
the OOD score is based on a probability of the one or more feature outputs from the first intermediate transformer layer belonging to the most likely class.

14. The apparatus of claim 8, wherein:
the at least one processing device is further configured to obtain one or more second feature outputs from a second intermediate transformer layer of the machine learning model; and
the OOD score is based on the one or more feature outputs from the first intermediate transformer layer, the one or more feature distributions, the one or more second feature outputs from the second intermediate transformer layer, and one or more second feature distributions from the second intermediate transformer layer obtained by passing the embedded in-distribution inputs through the machine learning model.

15. A non-transitory machine-readable medium containing instructions that when executed cause at least one processor to:
receive an input for a machine learning model having a transformer-based architecture, the transformer-based architecture comprising an embedding layer, an unembedding layer, and three or more transformer layers logically disposed between the embedding layer and the unembedding layer;
embed the input at the embedding layer and pass the embedded input from the embedding layer across the three or more transformer layers of the machine learning model, wherein each transformer layer is configured to provide one or more feature outputs;
obtain the one or more feature outputs from a first intermediate transformer layer of the three or more transformer layers;
generate an out-of-distribution (OOD) score for the received input based on the one or more feature outputs from the first intermediate transformer layer and one or more feature distributions from the first intermediate transformer layer obtained by passing embedded in-distribution inputs through the machine learning model;
compare the OOD score for the received input against a threshold; and
in response to determining that the OOD score for the received input exceeds the threshold, pass one or more outputs from the unembedding layer to one or more downstream processes.

16. The non-transitory machine-readable medium of claim 15, further containing instructions that when executed cause the at least one processor, in response to determining that the OOD score for the received input does not exceed the threshold, to at least one of:
not pass the one or more outputs from the unembedding layer to the one or more downstream processes; or
flag the one or more outputs of the unembedding layer as being based on an OOD input.

17. The non-transitory machine-readable medium of claim 15, wherein:
the instructions when executed cause the at least one processor generate the OOD score using a likelihood-based approach; and
the OOD score is a composite probability based on, for each of the one or more feature distributions from the first intermediate transformer layer, a probability that the one or more feature outputs from the first intermediate transformer layer belongs to that one of the one or more feature distributions.

18. The non-transitory machine-readable medium of claim 17, wherein:
the instructions when executed cause the at least one processor to generate the OOD score using a feature-based approach;
to use the feature distance-based approach, the instructions when executed cause the at least one processor to calculate a Mahalanobis distance between the one or more feature outputs from the first intermediate transformer layer and at least one of the one or more feature distributions from the first intermediate transformer layer; and
the OOD score is based on the Mahalanobis distance.

19. The non-transitory machine-readable medium of claim 17, wherein:
the instructions when executed cause the at least one processor to generate the OOD score using a network confidence-based approach;
to use the network confidence-based approach, the instructions when executed cause the at least one processor to determine a feature distribution of the one or more feature distributions from the first intermediate transformer layer as a most likely class for the one or more feature outputs from the first intermediate transformer layer; and
the OOD score is based on a probability of the one or more feature outputs from the first intermediate transformer layer belonging to the most likely class.

20. The non-transitory machine-readable medium of claim 15, further containing instructions that when executed cause the at least one processor to obtain one or more second feature outputs from a second intermediate transformer layer of the machine learning model;
wherein the OOD score is based on the one or more feature outputs from the first intermediate transformer layer, the one or more feature distributions, the one or more second feature outputs from the second intermediate transformer layer, and one or more second feature distributions from the second intermediate transformer layer obtained by passing the embedded in-distribution inputs through the machine learning model.
